(19) United States
(12) Patent Application Publication
(10) Pub. No.: US 2018/0088093 A1
(43) Pub. Date: Mar. 29, 2018

(54) DEVICE FOR THE VERIFICATION OF ORGANIC COMPOUNDS

(71) Applicants: KROHNE Messtechnik GmbH, Duisburg (DE); Fraunhofer-Gesellschaft zur Förderung der angewandten Forschung e.V., München (DE)

(72) Inventors: Steffen Ziesche, Dresden (DE); Christian Lenz, Dresden (DE); Michael Deilmann, Essen (DE); Winfred Kuipers, Essen (DE)

(73) Assignees: KROHNE Messtechnik GmbH, Duisburg (DE); Fraunhofer-Gesellschaft zur Förderung der angewandten Forschung e.V., München (DE)

(21) Appl. No.: 15/713,978

(22) Filed: Sep. 25, 2017

(30) Foreign Application Priority Data
Sep. 23, 2016 (DE) 10 2016 117 998.1

(51) Int. Cl. G01N 30/68

(52) U.S. Cl. CPC G01N 30/68; G01N 2030/025

(57) ABSTRACT

A device for the verification of organic compounds, comprising a miniaturized flame ionization detector (2) with a combustion chamber (3) for the analysis of a sample gas, having at least one oxygen feed line (4) to the combustion chamber (3), and having at least one hydrogen feed line (5) to the combustion chamber (3) and an electrolyzer for the generation of hydrogen and oxygen. To provide a device for the mobile verification of organic compounds, which has a low maintenance effort and a high reliability, the electrolyzer is designed as a PEM electrolyzer (6).

### BACKGROUND OF THE INVENTION

### Field of the Invention

The present invention relates to a device for the verification of organic compounds, comprising a miniaturized flame ionization detector with a combustion chamber for the analysis of a sample gas, having at least one oxygen feed line to the combustion chamber, and having at least one hydrogen feed line to the combustion chamber and an electrolyzer for the generation of hydrogen and oxygen.

### Description of Related Art

The use of flame ionization detectors for the verification of organic compounds, in particular of compounds containing hydrocarbon, is known from the prior art. The verification principle of a flame ionization detector is based on measuring the electrical conductivity of an oxyhydrogen flame, which is increased by the addition of compounds containing hydrocarbon. In detail, the sample gas to be analyzed is mixed with a fuel gas, preferably hydrogen, and both the gas mixture and an oxidizing agent, preferably oxygen or air, are fed to a combustion chamber. In the combustion chamber, the sample gas is ionized in an oxyhydrogen flame, which is arranged between two electrodes, and the ion current is measured as a measure for the concentration of the hydrocarbons in the sample gas. For this purpose, a DC voltage is applied to the electrodes.

Particularly the mobile use of flame ionization detectors, for example, for checking the leak-tightness of gas lines, as well as the use as a field device are of particular importance in practice. It is therefore known to design flame ionization detectors in miniaturized design.

In addition, it is also known from the prior art to use the electrolysis of aqueous solutions to generate hydrogen as fuel gas or oxygen as an oxidizing agent. As a result, it is possible to dispense of unwanted gas cylinders, which, in particular, also provide only a limited amount of hydrogen.

The European Patent Application EP 2 447 716 A1 discloses a device for the verification of organic compounds comprising a miniaturized flame ionization detector which is particularly versatile due to its small dimensions. Hydrogen and oxygen are produced, for example, by electrolysis of aqueous solutions. A disadvantage of the combination of a miniaturized flame ionization detector and the production of hydrogen or oxygen by means of electrolysis is that electrolytes, in particular salts, present in the aqueous solution settle in the miniaturized channels of the flame ionization detector and clog them by crystallization. As a result, a corresponding device is frequently cleaned or expensive filtering has to be carried out, and additionally, it is not possible to guarantee flawless operation.

### SUMMARY OF THE INVENTION

Thus, an object of the present invention is to provide a device for the verification of organic compounds which is suitable for use as a field device and which has a low maintenance effort and provides a high reliability.

According to a first teaching of the present invention, the aforementioned object is achieved by means of a device described in the introduction in that the electrolyzer is designed as a PEM electrolyzer, i.e. as an electrolyzer with a proton exchange membrane (PEM). The proton exchange membrane preferably consists of an ion-conducting membrane of defined thickness, electrodes deposited on both sides, and gas diffusion layers which are arranged above the electrodes.

The generation of hydrogen and oxygen by a PEM electrolyzer is based on the cleavage of distilled water into oxygen and positive hydrogen ions. The hydrogen ions diffuse through the membrane and combine with electrons to form hydrogen on the other side of the membrane. In this manner, hydrogen and oxygen are formed separately and are directly available for transmission to the flame ionization detector. According to the invention, it has been recognized that the production of hydrogen or oxygen by means of PEM electrolysis is particularly advantageous for verification with a miniaturized flame ionization detector, since the hydrogen or oxygen feed lines do not clog in contrast to the use of conventional electrolysis. Accordingly, the device according to the invention has the advantage that it only has a small maintenance effort and, at the same time, ensures particularly reliable operation.

According to a first preferred design, the oxygen and the hydrogen feed lines are arranged in such a manner that the oxygen and the hydrogen are introduced into the combustion chamber in opposite directions. Such an arrangement is also referred to as a countercurrent arrangement. In this arrangement, the impulses of the gases introduced into the combustion chamber essentially cancel each other out at the stagnation point, whereby the oxyhydrogen flame assumes a spherical shape. This is particularly stable since the heat emitted is particularly small due to the minimum surface area of a spherical flame. The ionization efficiency of this design is, thus, particularly high. In addition, due to the minimal flow rate at the stagnation point, little heat is lost by convection, on the one hand, and on the other hand, the sample to be analyzed lingers in the ionizing region which is beneficial for the sensitivity of the detector.

The use of a PEM electrolyzer in the above-described design is particularly advantageous, since unlike conventional electrolysis, the produced gases of hydrogen and oxygen do not have to be separated for the operation of the miniaturized flame ionization detector, but are already separated from one another in the electrolyzer, as previously explained. To this extent, the above described design of the device according to the invention can be operated in a particularly simple manner.

In addition, it is also preferred when the oxygen feed line and the hydrogen feed line lead into the combustion chamber at an angle to one another of between 90° and 180°. A particularly stable flame shape can also be produced according to such a design. In addition, it is also advantageous when more than one hydrogen feed line and more than one oxygen feed line to the combustion chamber are present, wherein preferably an oxygen feed line and a hydrogen feed line are lead into the combustion chamber in opposite directions.

According to a further design, at least one sample gas feed line is provided that opens into the hydrogen feed line so that a gas mixture of hydrogen and sample gas can be fed to the combustion chamber.

The device according to the invention can be further improved by providing a water reservoir for the PEM electrolyzer and a return line, wherein the return line connects the combustion chamber to the water reservoir. By means of such a return line, the condensate accumulating in the combustion chamber or, as the case may be, in discharge paths connected to the combustion chamber can be fed back into the water reservoir, filling the latter. This design has the additional advantage that an external filling of the water reservoir can be dispensed with, whereby the mobile use of a device according to this design is further simplified.

According to a further preferred design, one or more sensors are provided, which further improve the reliability of a device according to the invention and increase operational safety. Particularly preferably, at least one flow sensor is provided in the oxygen and/or the hydrogen feed line. This design has the advantage that the stream of hydrogen or oxygen introduced into the combustion chamber can be measured and can thus be introduced into the combustion chamber in a controlled manner. In particular, the flame shape can be influenced by the controlled inlet of hydrogen or oxygen.

Alternatively, or additionally, at least one moisture sensor is present in the oxygen and/or the hydrogen feed line, which measures the residual moisture in the oxygen and/or hydrogen feed line.

Alternatively, or additionally, at least one pressure sensor is present in the oxygen and/or the hydrogen feed line, wherein the measurement of the pressure within the lines ensures safe operation of the device.

Alternatively, or additionally, at least one temperature sensor for measuring the temperature of the hydrogen and/or the gas mixture of sample gas and hydrogen and/or oxygen is present in the oxygen and/or the hydrogen feed line. In addition, a temperature sensor can also be arranged in the sample gas feed line. Preferably, the temperature sensor is arranged immediately before the combustion chamber, whereby the temperature at which the gases are passed into the combustion chamber can be monitored.

Alternatively, or additionally, a further temperature sensor is arranged within the combustion chamber that monitors the temperature of the combustion chamber to increase operational safety.

Alternatively, or additionally, at least one fill level sensor is present in the water reservoir of the PEM electrolyzer, which measures the water level in the water reservoir. By measuring the water level, it is possible to prevent the water reservoir from emptying completely.

According to a further embodiment, at least one heating element is provided for heating the hydrogen and/or the oxygen and/or the sample gas and/or the gas mixture of hydrogen and sample gas. The aforementioned heating of a gas or gases improves the measuring characteristics of the flame ionization detector. The hydrogen and/or the oxygen and/or the sample gas and/or the gas mixture of hydrogen and sample gas is/are preferably heated to a temperature of approximately 200° C. Particularly preferably, the at least one heating element is arranged in at least one feed line directly in front of the combustion chamber, whereby a targeted heating of the gas or of the gases takes place before entry into the combustion chamber.

Furthermore, it is advantageous when a cooling trap is present, wherein the cooling trap is arranged in the region of the hydrogen feed line and/or the oxygen feed line between the PEM electrolyzer and the combustion chamber. Any water or residual moisture present in the hydrogen feed line and/or the oxygen feed line can thus be removed from the hydrogen and/or the oxygen.

According to a further preferred design, the miniaturized flame ionization detector is produced by means of ceramic multi-layer technology. The miniaturized flame ionization detector is particularly preferred as a ceramic monolith. This has the advantage that, in the event of temperature changes in the operating temperature, no thermal stress is produced as a result of different expansion characteristics of different materials. In addition, the miniaturized flame ionization detector designed as a ceramic monolith is particularly resistant to various chemicals. In this respect, a device according to the invention, wherein the miniaturized flame ionization detector is designed as a ceramic monolith, has the advantage that the measurement of organic compounds is particularly reliable even under difficult conditions.

It is also preferred when the PEM electrolyzer is produced of half-shells based on ceramic multi-layer technology or on the basis of an alternative shaping process, such as injection molding or extrusion, using plastic or ceramic. The use of further suitable materials is likewise conceivable. A material is suitable if the material does not interact with the electrolysis gases hydrogen and oxygen. The use of ceramic as opposed to plastic, for example, is particularly advantageous because of its particularly high resistance to external environmental influences such as chemicals or temperature fluctuations. It is also possible, as described below, to provide a device comprising a one-piece design of PEM electrolyzer and miniaturized flame ionization detector.

According to a further design of the device according to the invention, the PEM electrolyzer and the flame ionization detector are produced by means of ceramic multi-layer technology, and the miniaturized flame ionization detector and the PEM electrolyzer are designed as a ceramic monolith. Firstly, this design has the advantage that the device according to the invention is designed as a one-piece component, whereby the design and thus also the use as a field device of a device according to this embodiment is simplified. In addition, the previously described design has a particularly high reliability in that the ceramic monolith is particularly robust against temperature changes and is particularly resistant to chemicals.

It is particularly advantageous when the previously described ceramic monolith consisting of a PEM electrolyzer and a miniaturized flame ionization detector is designed as a SMD (surface mounted device) component. According to this design, electrical and fluidic connections are arranged on the underside of the device. In this design, the device can be applied and connected to a macroscopic substrate in a particularly simple manner in one step.

According to a further preferred design, the PEM electrolyzer is produced by means of ceramic multi-layer technology, and a current source for the electrolyzer and/or a control and evaluation unit for the filling level sensor is provided, and the current source and/or the control and evaluation unit is/are applied to the surface of the PEM electrolyzer by means of SMD components. Since multi-layer ceramics are mainly used as circuit cards, the above-described use of SMD components is possible. This design has the advantage of a maximum miniaturization as well as a simplification of the construction of a device according to the invention.

According to a similarly preferred design, the miniaturized flame ionization detector is produced by means of ceramic multi-layer technology and a voltage supply for a suction (negative) voltage applied within the combustion chamber, and/or a device for measuring an ion current, and/or at least one control and evaluation unit for the flow sensor and/or the moisture sensor and/or the pressure sensor and/or the temperature sensor is/are provided, and the voltage supply and/or the device for measuring the ion current and/or the at least one control and evaluation unit is/are applied to the surface of the miniaturized flame ionization detector with the help of SMD components.

It is also particularly preferred when a miniaturized gas chromatograph comprising a separation column and a detector is present, wherein the miniaturized gas chromatograph is integrated into the device according to the invention in such a manner that the separation column is arranged between the PEM electrolyzer and the miniaturized flame ionization detector and the miniaturized flame ionization detector is used as a detector of the gas chromatograph. According to this design, the hydrogen gas of the flame ionization detector is preferably used as the carrier gas of the gas chromatograph.

According to an advantageous design, the PEM electrolyzer and/or the miniaturized gas chromatograph and/or the miniaturized flame ionization detector are produced on the basis of ceramic multi-layer technology.

This design comprises devices, in which the components PEM electrolyzer, gas chromatograph and flame ionization detector are produced using the same method, as well as devices, in which the aforementioned components are produced using different methods and/or using the same or different materials.

It is particularly preferred that the PEM electrolyzer and the miniaturized gas chromatograph and the miniaturized flame ionization detector are produced based on ceramic multi-layer technology, and the device comprising the PEM electrolyzer, the gas chromatograph and the miniaturized flame ionization detector is designed as a ceramic monolith.

In detail there is a plurality of possibilities for designing the device for the verification of organic compounds according to the invention. Reference is made to the patent claims subordinate to the independent patent claims as well as to the following description of preferred embodiments in conjunction with the drawing. The drawing shows:

### BRIEF DESCRIPTION OF THE DRAWINGS

FIG. 1 is a schematic representation of a first embodiment of a PEM electrolyzer,

FIG. 2 is a schematic representation of a first embodiment of a device according to the invention,

FIG. 3 is a schematic representation of a second embodiment of a device according to the invention, and

FIG. 4 is a schematic representation of a third embodiment of a device according to the invention.

### DETAILED DESCRIPTION OF THE INVENTION

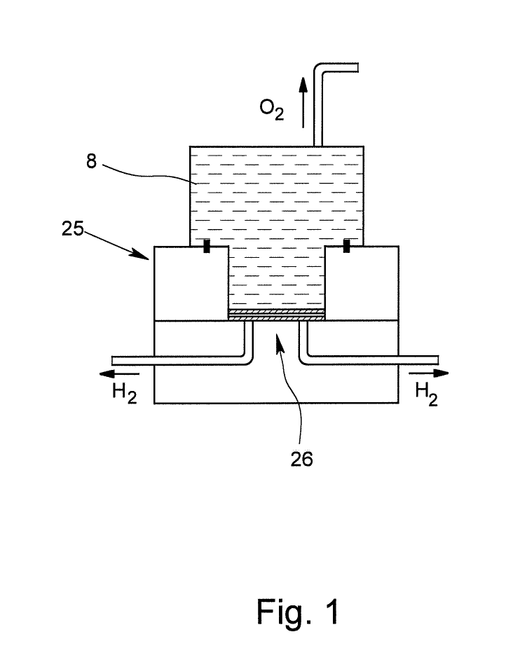

FIG. 1 shows a first embodiment of a PEM electrolyzer 7 for the generation of hydrogen and oxygen. The PEM electrolyzer 7 is formed of two structured and functionalized ceramic half-shells, between which the electro-chemically active component 26 is arranged. The electro-chemically active component 26 is comprised of an ion-conducting membrane of defined thickness, electrodes deposited on both sides, and the gas diffusion layers placed over the electrodes. The aforementioned components are designed and arranged such that the cell internal resistance is minimal. The ceramic half-shells are structured in such a manner that both anode-side contact with water and the anode and cathode-side removal of the electrolysis gases is possible. Furthermore, the half-shells are provided with a suitable electrically conductive metallization, by means of which an electrical contacting of the electrodes located on the membrane is achieved. The separation of the electrolysis gases hydrogen and oxygen is achieved by a seal which is also integrated between the ceramic half shells. The electrolysis unit is braced in a housing 25, which ensures a defined pressing of the unit. The electrolysis gases can be removed via the housing 25. In addition, a water reservoir 8 is integrated into the housing.

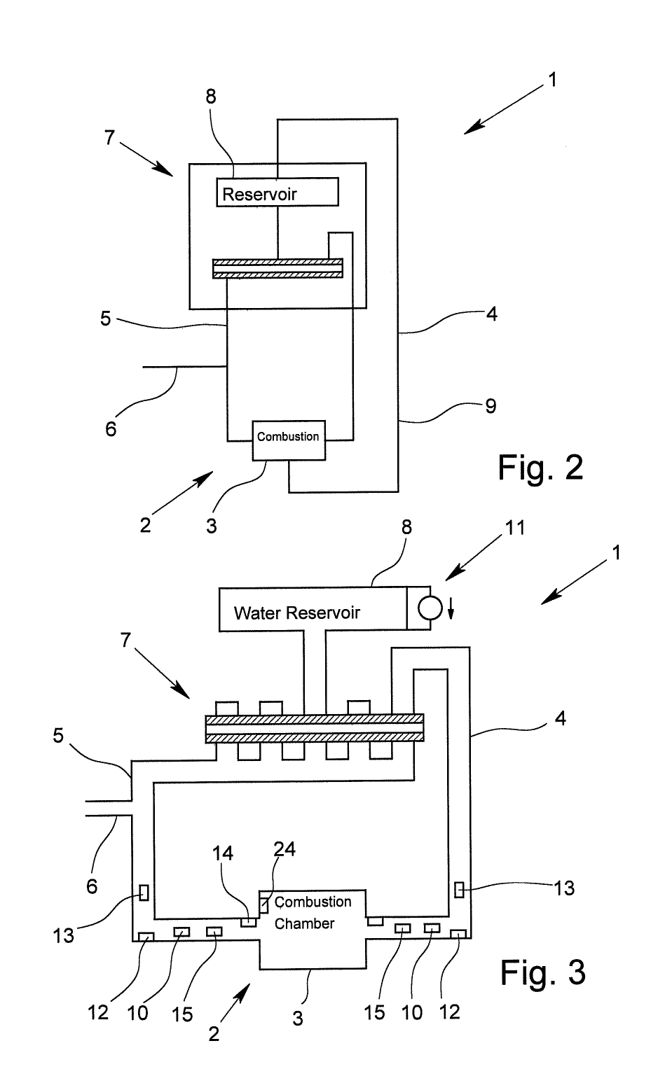

FIG. 2 schematically shows a first embodiment of a device 1 according to the invention for the verification of organic compounds, in particular of compounds containing hydrocarbons. The illustrated device 1 comprises a miniaturized flame ionization detector 2 having a combustion chamber 3, in which the sample gas is analyzed, having an oxygen feed line 4 to the combustion chamber 3 and having a hydrogen feed line 5 to the combustion chamber 3. In addition, a sample gas feed line 6 opens into the hydrogen feed line 5 so that a gas mixture of hydrogen and sample gas can be introduced into the combustion chamber 3 via the hydrogen feed line 5. In the combustion chamber 3, during operation of the device 1, the sample gas is ionized in an oxyhydrogen flame and the ion current is measured. The ion current is proportional to the hydrocarbon content of the sample gas over a wide concentration range.

A PEM electrolyzer 7 is provided for the generation of hydrogen and oxygen. The use of a PEM electrolyzer 7 is particularly advantageous in combination with a miniaturized flame ionization detector, since the production of hydrogen and oxygen is effected in a particularly simple manner, wherein the gases are already present separately from one another as they arise, so that the use of unwieldy gas bottles can be dispensed with. In addition, the use of a PEM electrolyzer 7, unlike conventional electrolyzers, surprisingly has the advantage that no electrolytes, such as, e.g., salts, clog the miniaturized feed lines. Cleaning the device and filtering is therefore not necessary. To this extent, a device 1 is shown which provides a particularly low maintenance effort and which, furthermore, has a particularly high reliability. When taking into consideration that such miniaturized devices possibly cannot be maintained or cleaned at a reasonable cost, then the device presented has a very long service life before it has to be replaced.

In the embodiment shown, the oxygen feed line 4 and the hydrogen feed line 5 are arranged in such a manner that the oxygen and the hydrogen are directed in opposite directions into the combustion chamber 3 and flow directly towards one another. This design, which is, thus, also referred to as a countercurrent arrangement, has the advantage that the oxyhydrogen flame arranged in the combustion chamber 3 during operation of the device 1 provides a particularly high ionization efficiency. Due to the opposite introduction of hydrogen and oxygen, the impulses of the gases cancel each other out at the stagnation point, so that the oxyhydrogen flame assumes a spherical shape. Due to the small surface, the heat exchange with the environment is particularly low, which in turn increases the ionization efficiency. Moreover, due to the minimum flow velocity of the gases at the stagnation point, little heat is lost by convection, and additionally, the sample to be analyzed lingers in the ionizing region which is beneficial for the sensitivity of the detector.

Furthermore, a water reservoir 8 is provided in which the water which is supplied to the electrolyzer 7 is located during operation of the device 1. In addition, a return line 9 is provided that connects the combustion chamber 3 to the water reservoir 8. For example, condensate accumulating in the combustion chamber 3 or first in the return line 9 can be fed back into the water reservoir 8 via the return line 9, whereby the water reservoir 8 is filled. By means of the closed circulation system, a refilling of the water reservoir 8 can largely be dispensed with, whereby the suitability of the illustrated device 1, in particular for mobile use, is considerably improved.

FIG. 3 shows a second embodiment of a device 1 according to the invention for the verification of organic compounds. FIG. 3 also has a miniaturized flame ionization detector 2 with a combustion chamber 3 for the analysis of the sample gas, an oxygen feed line 4, a hydrogen feed line 5 and a sample gas feed line 6 that opens into the hydrogen feed line 5. A PEM electrolyzer 7 is provided for the generation of hydrogen and oxygen. The water to be supplied to the PEM electrolyzer 7 is arranged in a water reservoir 8 during operation of the device 1.

In addition, the device 1 has various sensors 10, 11, 12, 13, 14, 24 which improve the reliability of the verification of organic compounds, in particular the measurement of compounds containing hydrocarbon, and increase operational safety. A flow sensor 10 is arranged, in each case, in the oxygen feed line 4 and in the hydrogen feed line 5, the flow sensor measuring the flow velocity of the hydrogen or oxygen during operation. Based on this information, the supply of the gases to the combustion chamber 3 can be controlled. Preferably, inflow regulators (not shown) are provided for this purpose.

Furthermore, the device 1 shown in FIG. 3 has a fill level sensor 11 in the water reservoir 8, which, in the present case, is designed as a capacitive fill level sensor 11. The fill level sensor 11 measures the level of the water in the water reservoir 8 during operation. As a result, it is possible to prevent the water reservoir 8 from being completely emptied, whereby the operation of the device 1 would have to be interrupted. It can therefore be ensured that the water reservoir 8 is replenished in time, i.e. before it is empty, in order to guarantee a permanent operation of the device 1.

Furthermore, a moisture sensor 12 is provided in the hydrogen feed line 5 and in the oxygen feed line 4, which measures the moisture in the oxygen gas or hydrogen gas during operation.

In the oxygen feed line 4 and in the hydrogen feed line 5, pressure sensors 13 are arranged, which monitor the pressure prevailing in the feed lines 5 during operation of the device 1. These pressure sensors 13 guarantee safe operation of the device 1.

Finally, temperature sensors 14, which measure the temperature of the hydrogen or the oxygen upstream of the combustion chamber 3, are arranged directly in front of the combustion chamber 3 in the feed lines 4 and 5. If the gases are heated, preferably to about 200° C., before introduction into the combustion chamber 3, the measuring properties of the miniaturized flame ionization detector 2 are improved. Another temperature sensor 24 is arranged in the combustion chamber 3, which monitors the temperature within the combustion chamber 3.

In order to heat the gases to be introduced into the combustion chamber 3, heating elements 15 are arranged in front of the combustion chamber 3 both in the hydrogen feed line 5 and in the oxygen feed line 4, which, during operation, heat the gases to be introduced into the combustion chamber 3.

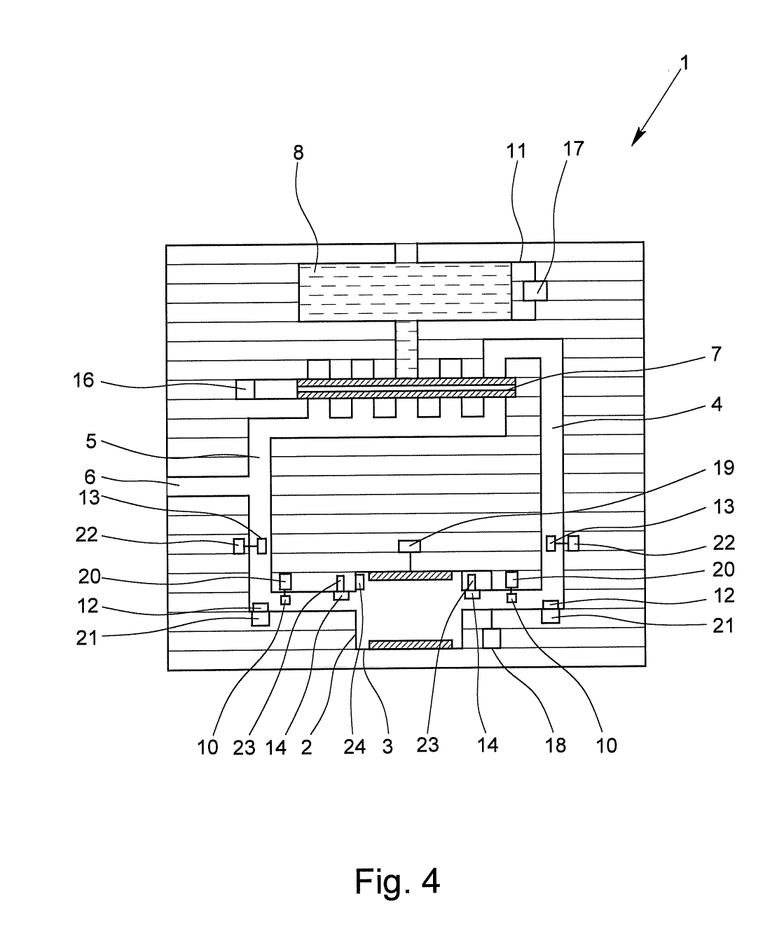

FIG. 4 shows a further, third embodiment of a device 1 according to the invention. FIG. 4 shows a miniaturized flame ionization detector 2 with a combustion chamber 3 for analyzing the sample gas, an oxygen feed line 4 to the combustion chamber 3 and a hydrogen feed line 5 to the combustion chamber 3, wherein a sample gas feed line 6 is also provided that opens into the hydrogen feed line 5 and via which the sample gas can be directed into the hydrogen feed line 5 and, thus, into the combustion chamber 3 as a gas mixture. A PEM electrolyzer 7 is provided for the generation of hydrogen and oxygen. In addition, a water reservoir 8 is provided for receiving and providing the water to be supplied to the electrolyzer 7.

According to the embodiment shown, both the miniaturized flame ionization detector 2 and the PEM electrolyzer 7 are produced by means of ceramic multi-layer technology. In the present case, the miniaturized flame ionization detector 2 and the PEM electrolyzer 7 are designed as a ceramic monolith. This has the advantage that the illustrated device 1 is designed as one component, whereby the design and, thus, use in the field of the device 1 is simplified. Moreover, the embodiment shown has a particularly high reliability in that the ceramic monolith is particularly robust against temperature changes and is particularly resistant to chemicals.

Due to the design as a ceramic monolith, it is possible and also advantageous to use SMD components. In the present case, a current source 16 for the electrolyzer is provided which is applied to the surface of the electrolyzer with the help of a SMD component. In addition, a control and evaluation unit 17 is provided for the fill level sensor 11, which is also applied to the surface of the electrolyzer by means of SMD components.

In addition, a voltage supply 18 for the suction (negative) voltage applied in the combustion chamber 3, a device for measuring the ion current 19, and a control and evaluation unit 20, 21, 22, 23 for each of the flow sensor 10, the humidity sensor 12, the pressure sensor 13 and the temperature sensor 14 are implemented.

Ultimately, a device 1 for the verification of organic compounds is provided, which, on the one hand, has a particularly low maintenance effort, a particularly high reliability and a particularly good suitability for use as a field device.

What is claimed is:

1. A device for the verification of organic compounds, comprising:
a miniaturized flame ionization detector with a combustion chamber for analysis of a sample gas,
at least one oxygen feed line connected to the combustion chamber,
at least one hydrogen feed line connected to the combustion chamber, and
an electrolyzer for the generation of hydrogen and oxygen,
wherein the electrolyzer is a Polymer Electrolyte Membrane (PEM) electrolyzer.

2. The device according to claim 1, wherein the oxygen feed line and the hydrogen feed line are arranged such that the oxygen and the hydrogen are introduced into the combustion chamber in opposite directions.

3. The device according to claim 1, wherein at least one sample gas feed line is provided which opens into the hydrogen feed line so that a gas mixture of hydrogen and sample gas is able to be fed to the combustion chamber.

4. The device according to claim 1, wherein a water reservoir for the PEM electrolyzer and a return line are provided, and wherein the return line connects the combustion chamber to the water reservoir.

5. The device according to claim 1, wherein at least one flow sensor, at least one moisture sensor, at least one pressure sensor and at least one temperature sensor are provided in at least one of the oxygen feed line, the hydrogen feed line and the combustion chamber, and wherein at least one fill level sensor is present in the water reservoir.

6. The device according to claim 1, wherein at least one flow sensor, is provided in at least one of the oxygen feed line, the hydrogen feed line and the combustion chamber, and wherein at least one fill level sensor is present in the water reservoir.

7. The device according to claim 1, wherein at least one pressure sensor is provided in at least one of the oxygen feed line, the hydrogen feed line and the combustion chamber, and wherein at least one fill level sensor is present in the water reservoir.

8. The device according to claim 1, wherein at least one temperature sensor is provided in at least one of the oxygen feed line, the hydrogen feed line and the combustion chamber, and wherein at least one fill level sensor is present in the water reservoir.

9. The device according to claim 3, wherein at least one heating element is provided for heating at least one of the hydrogen feed, the oxygen feed, the sample gas feed and the gas mixture of hydrogen and sample gas.

10. The device according to claim 1, wherein a cooling trap is provided, wherein the cooling trap is arranged between the PEM electrolyzer and the combustion chamber in a region of at least one of the hydrogen feed line and the oxygen feed line.

11. The device according to claim 1, wherein the miniaturized flame ionization detector has a ceramic multi-layer construction.

12. The device according to claim 1, wherein the PEM electrolyzer comprises multi-layer ceramic half-shells.

13. The device according to claim 1, wherein the PEM electrolyzer and the miniaturized flame ionization detector are made of a multi-layer ceramic,

14. The device according to claim 13, wherein the miniaturized flame ionization detector and the PEM electrolyzer are a ceramic monolith.

15. The device according to claim 14, wherein the ceramic monolith formed of the PEM electrolyzer and the miniaturized flame ionization detector are an SMD component.

16. The device according to claim 1, wherein the PEM electrolyzer is comprised of a multi-layer ceramic, and wherein at least one of a current source for the electrolyzer, and a control and evaluation unit is provided for the fill level sensor and wherein said at least one of the current source and the control and evaluation unit is applied to a surface of the PEM electrolyzer by means of SMD components.

17. The device according to claim 1, wherein the miniaturized flame ionization detector comprises a multi-layer ceramic, wherein a voltage supply for at least one of a suction (negative) voltage applied within the combustion chamber, a device for measuring ion current and at least one control and evaluation unit is provided for at least one of a flow sensor, a moisture sensor, a pressure sensor and a temperature sensor, and wherein the at least one of the voltage supply, the device for measuring ion current and the at least one control and evaluation unit is applied on a surface of the miniaturized flame ionization detector via SMD components.

18. The device according to claim 1, further comprising a miniaturized gas chromatograph comprising a separation column and a detector, wherein the miniaturized gas chromatograph is integrated with the separation column arranged between the PEM electrolyzer and the miniaturized flame ionization detector, and wherein the miniaturized flame ionization detector serves as a detector of the gas chromatograph.

19. The device according to claim 18, wherein at least one of the PEM electrolyzer, the miniaturized gas chromatograph and the miniaturized flame ionization detector is formed of a multi-layer ceramic.

20. The device according to claim 19, wherein the PEM electrolyzer, the miniaturized gas chromatograph and the miniaturized flame ionization detector are formed as a multi-layer ceramic monolith.
